(19) United States
(12) Patent Application Publication
(10) Pub. No.: US 2006/0146790 A1
(43) Pub. Date: Jul. 6, 2006

(54) System and method for providing reach me cover me feature in a session initiation protocol (SIP) environment

(75) Inventors: Denise G. Caballero-McCann, Raleigh, NC (US); Ta-Ming Chen, Cary, NC (US); Stephen Levy, Cary, NC (US); Kannan Rajagopalan, Apex, NC (US); Gerardo Chaves, Los Angeles, CA (US); Marc Coiner Ayres, Allen, TX (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/026,389

(22) Filed: Dec. 30, 2004

(51) Int. Cl. H04L 12/66

(52) U.S. Cl. 370/352; 370/389

(57) ABSTRACT

A method for facilitating communication in a Session Initiation Protocol (SIP) environment is provided that includes receiving, by a first endpoint, dialog and presence information associated with a second endpoint. The first and second endpoints are operable to conduct a SIP communication system. The method also includes identifying the dialog and presence information associated with the second endpoint.

### TECHNICAL FIELD OF THE INVENTION

This invention relates generally to communications and, more particularly, to a system and a method for providing a reach me cover me feature in a Session Initiation Protocol (SIP) environment.

### BACKGROUND OF THE INVENTION

The field of communications is becoming increasingly complex in today's society. In particular, the ability to quickly and to effectively interact with an individual (through any suitable communications media) presents a significant obstacle for component manufacturers, system designers, and network operators. This obstacle is made even more difficult due to the plethora of diverse communication technologies (e.g. Instant Messaging, cellular communications, simple voice sessions, etc.) that exist in the current marketplace.

As new communication platforms (such as session initiation protocol (SIP), for example) become available to the consumer, new application mechanisms need to be developed in order to optimize this emerging technology. For example, some problems often encountered by a caller in any communications environment are being unable to reach or to cover a called party and, further, to identify the availability of the called party. This inability prohibits a given entity from adequately communicating with the targeted party or from properly covering incoming calls. Accordingly, this deficiency presents an obstacle for any employee, employer, individual, or endpoint that seeks to execute successful and productive communication sessions.

### SUMMARY OF THE INVENTION

From the foregoing, it may be appreciated by those skilled in the art that a need has arisen for an improved process that provides an effective solution for the challenges faced by participants in a complex communications architecture. In accordance with an embodiment of the present invention, a system and a method for providing a reach me cover me functionality are provided that substantially eliminate or greatly reduce disadvantages and problems associated with conventional communication strategies and protocols.

According to an embodiment of the present invention, a method for facilitating a data session in a Session Initiation Protocol (SIP) environment is provided that includes receiving, by a first endpoint, dialog and presence information associated with a second endpoint. The first and second endpoints are operable to conduct a SIP communication system. The method also includes identifying the dialog and presence information associated with the second endpoint.

In more particular embodiments, various alternative methods may include performing a selected one of a plurality of operations after reviewing the dialog and presence information. The selected operation may be one of a call setup operation, a call pickup operation, and a call barge operation. In still other embodiments, the second endpoint is part of a called persons list or a covered persons list that is part of a pre-defined group. The called persons list or the covered persons list may be generated dynamically.

Certain embodiments of the present invention may provide a number of technical advantages. For example, according to one embodiment of the present invention, an architecture and a process are provided that avoid time-consuming endeavors that inhibit productivity. The reach me cover me feature allows for the dynamic set of a list of targets (lines) to be monitored. The feature initiator can decide what the best action is to reach or to cover the monitored person. This decision can be based on the combination of their presence and dialog state.

Moreover, the proffered architecture can provide a single consolidated user interface (e.g. for a personal assistant, co-worker, etc.) that indicates the best way to reach or to cover a call. The configuration also offers a simple interface to initiate the cover or the reach operation (i.e. one-button push). The architecture can interpret a person's intention based on the depressed button selection. For example, in the case of a ringing phone icon being depicted on a display, if the end user presses the reach me cover me button, then the system understands that the end user would like to receive the call. In another instance, where the same phone is not ringing, pressing the button would indicate that the end user would like to call a given individual. The system recognizes that, because the end user understands the state of the targeted individual, it can rely on the end user button selection to execute a subsequent function or operation.

Additionally, in more simplistic scenarios, the reach me cover me capability could allow a receiving party to have all incoming calls covered. Similarly, the reach me feature allows for optimal interaction between corresponding parties. Also, a higher number of successful calls are completed using the reach me cover me feature, which vastly improves efficiency parameters (particularly in the workplace). Furthermore, such features may be activated with minimal individual effort from either participating party, as some of the reach me cover me operations may be performed autonomously.

Certain embodiments of the present invention may enjoy some, all, or none of these advantages. Other technical advantages may be readily apparent to one skilled in the art from the following figures, description, and claims.

### BRIEF DESCRIPTION OF THE FIGURES

To provide a more complete understanding of the present invention and features and advantages thereof, reference is made to the following description, taken in conjunction with the accompanying figures, wherein like reference numerals represent like parts, in which:

FIG. 1 is a simplified block diagram illustrating a communication system that may implement a reach me cover me feature in accordance with one embodiment of the present invention;

FIG. 2 is a simplified flowchart of an example operational flow of the communication system of FIG. 1; and

FIG. 3 is a simplified example schematic illustrating an operation of the system of FIG. 1 according to some of the teachings of the invention.

### DETAILED DESCRIPTION OF THE INVENTION

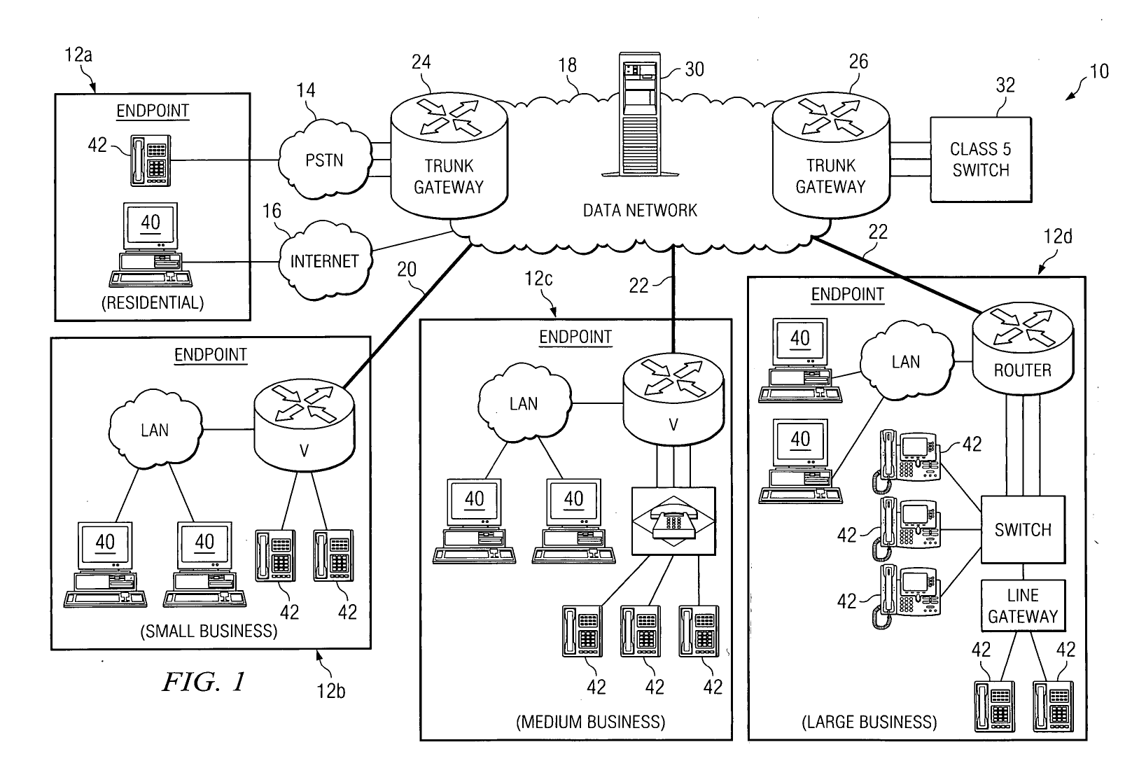

FIG. 1 is a simplified block diagram of a communication system 10 for implementing a reach me cover me feature, which optimizes communicating, receiving, and transmitting data in a session initiation protocol (SIP) environment. Communication system 10 includes endpoints 12a-12d, a public switched telephone network (PSTN) 14, the Internet 16, a service provider data network 18, a broadband access link 20, and a number of additional links 22 (which may include, for example, a digital subscriber line (DSL) link, a T1 link, a fiber optic link, and a wireless link). Communication system 10 also includes a set of trunk gateways 24 and 26, a 3rd-party application server 30, and a Class-5 switch 32.

Endpoint 12a represents a residential location, which consists of a computer 40 and several telephones 42. Telephones 42 may be an Internet protocol (IP) telephone or a standard telephone that is operable to interface with computer 40 such that one or more capabilities of SIP are enabled through telephone 42. Accordingly, two types of telephones are illustrated in FIG. 1. Endpoint 12b represents a small business entity, which consists of a local area network (LAN), a router, several computers 40, and several telephones 42. Endpoint 12c represents a medium business entity, which consists of a LAN, router, a private branch exchange (PBX) or key system, several computers 40, and several telephones 42. Endpoint 12d is a large business entity, which consists of a LAN, a router, a switch, a line gateway, several computers 40, and several telephones 42.

In accordance with the teachings of the present invention, communication system 10 offers a new reach me cover me technology service that allows for effective reach and cover operations to facilitate an optimal call session. This architecture allows a single button or a key on a phone to have complete interaction with another user's phone based on presence and dialog information. Once invoked, the button can perform any number of operations based on the presence state and dialog state. The operations could relate to a call setup, a call pickup, or a call barge, for example. The end user can recognize the action that will occur based on the presence or dialog display associated with the button. The called or covered persons list can be part of a pre-defined group or it can simply be added dynamically.

Note that in conventional telephony systems there are several variations of services that allow a user to either add a person to a speed dial list or that allow a feature initiator to “pick up” or “barge” into another person's call. However, these features are usually implemented in isolation and are lacking in sophistication and convenience. They may also use proprietary PBX technologies. Communication system 10 effectively addresses these two aspects, as well as many others as outlined herein. Additionally, for the implementation of speed dial, the speed dial number is not necessarily fixed. Moreover, the covered or called person's presence information can be used to determine the target of the call. Within communication system 10, a feature initiator can add new targets to be covered or called dynamically by simply subscribing to their dialog and presence states.

The SIP technology supports a presence capability to query for a callee's presence. This would provide a presence availability status for the caller, as well as location information, device information, and any personal presence status that the callee wishes to communicate to the calling party. Hence, communication system 10 builds on existing SIP capabilities and, further, extends them to provide enhanced information to the calling party. This can be achieved using a voice over IP (VoIP) platform built with SIP signaling in particular embodiments.

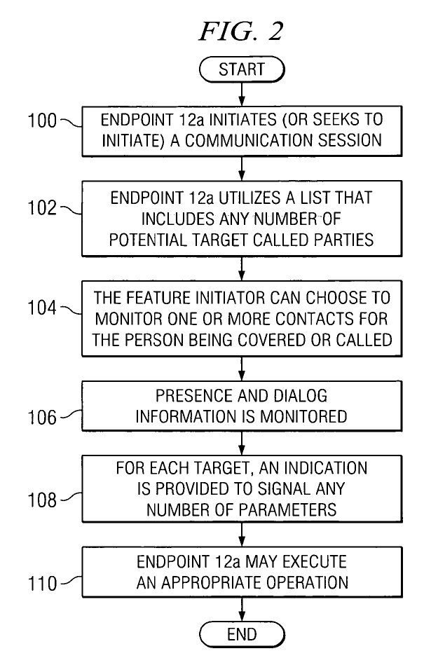

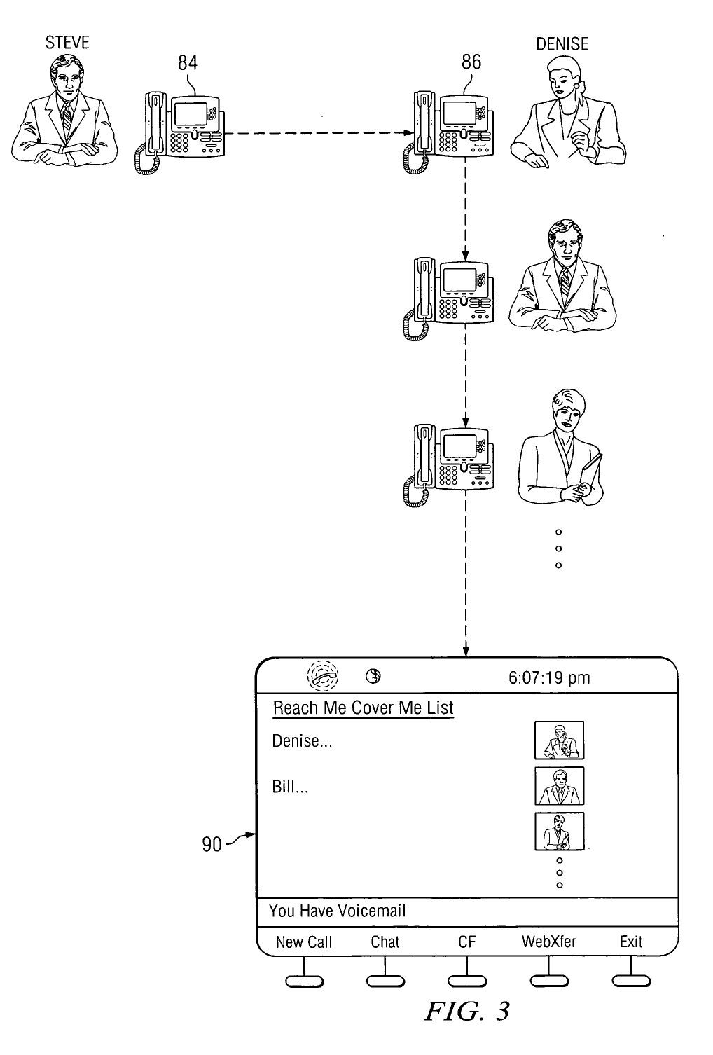

Communication system 10 combines the knowledge of the user's dialog and presence state to provide a one-button service to reach a person or to cover their calls. Unlike traditional PBX implementations for “directed pickup,” users do not need to enter a “feature code” before picking up a call by pressing the “speed dial” button representing the line on which a call is being offered. This application could most likely be used by a personal assistant. In order to further explain and detail these operations and others, a number of additional examples are provided herein in this document and discussed below with reference to FIGS. 2-3.

Endpoints 12a-d are SIP-compatible elements that include hardware and/or software that is operable to receive and to transmit data (directly or indirectly) and to implement the reach me cover me feature as outlined herein. Note that the term “endpoint” encompasses a myriad of potential devices and infrastructure that may benefit from the operations of communication system 10. Endpoints 12a-d may be a personal digital assistant (PDA), a cellular telephone, a standard telephone (which may be coupled to a personal computer) an IP telephone, a personal computer, a laptop computer, a mobile telephone, or any other suitable device or element (or any appropriate combination of these elements) that is operable to receive data or information. Each endpoint may also include suitable network equipment and appropriate infrastructure (e.g., switches, routers, LANs, gateways, etc.) to facilitate a SIP session. FIG. 1 illustrates only one set of example devices that may be used within communication system 10. The present invention is replete with numerous alternatives that could be used to facilitate the operations of communication system 10.

Note that the term “endpoint” may also encompass a “persona.” Entities that participate in call each generally have a persona. The persona represents an aggregation of the various devices and/or logical addresses that can be used by a person to communicate with another. For example, the persona of an employee named Denise could be represented by her phone number, her fully qualified domain name, her e-mail address, and/or the IP address port of her Instant Messaging application on her personal computer. Any number of these variables (or others) could be used to reflect Denise's persona.

It should also be noted that the internal structure of endpoints 12a-d are malleable and can be readily changed, modified, rearranged, or reconfigured in order to achieve their intended operations as they pertain to the reach me cover me function. As identified supra, software and/or hardware may reside in endpoints 12a-d in order to achieve the teachings of the reach me cover me feature of the present invention. However, due to their flexibility, these elements may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structure of endpoints 12a-d in the context of communication system 10 and, accordingly, should be construed as such.

For purposes of teaching and discussion, it is useful to provide some overview as to the way in which the following invention operates in a SIP environment. The following foundational information may be viewed as a basis from which the present invention may be properly explained. Such information is offered earnestly for purposes of explanation only and, accordingly, should not be construed in any way to limit the broad scope of the present invention and its potential applications.

There are many applications that require the creation and management of a session, where a session is considered an exchange of data between an association of participants. The implementation of these applications is complicated by the practices of participants: users may move between endpoints, they may be addressable by multiple names, and they may communicate in several different media: in many cases simultaneously. Certain protocols have been developed to carry various forms of real-time multimedia session data such as voice, video, or text messages.

The SIP features of communication system 10 work in concert with these protocols by enabling endpoints (generally referred to as “user agents”) to discover one another and to agree on a characterization of a session they would like to share. For locating prospective session participants, and for other functions, SIP enables the creation of an infrastructure of network hosts (generally referred to as proxy servers) to which user agents can send registrations, invitations to sessions, and other requests. SIP is an agile, general-purpose tool for creating, modifying, and terminating sessions. SIP works independently of underlying transport protocols and without dependency on the type of session that is being established.

SIP is an application-layer control protocol that can establish, modify, and terminate multimedia sessions (conferences) such as Internet telephony calls. SIP can also invite participants to already existing sessions, such as multicast conferences. Media can be added to (and removed from) an existing session. SIP transparently supports name mapping and redirection services, which supports personal mobility. End users can maintain a single externally visible identifier regardless of their network location.

SIP supports five facets of establishing and terminating multimedia communications: 1) user location: determination of the end system to be used for communication; 2) user availability: determination of the willingness of the called party to engage in communications; 3) user capabilities: determination of the media and media parameters to be used; 4) session setup: “ringing” establishment of session parameters at both called and calling party locations; and 5) session management: including transfer and termination of sessions, modifying session parameters, and invoking services.

A standard SIP platform does not provide services. Rather, SIP provides primitives that can be used to implement different services. For example, SIP can locate a user and deliver an opaque object to his current location. If this primitive is used to deliver a session description written in SDP, for instance, the endpoints can agree on the parameters of a session. Similar primitives may be used to deliver the dialog and presence information needed for implementing the reach me cover me service.

FIG. 2 is a simplified flowchart illustrating a number of example steps associated with a method to be performed within communication system 10. Before beginning the discussion of the flowchart, it is appropriate to summarize a number of features that are offered by SIP. First, there is a mechanism in the SIP protocol that allows a user to register multiple contacts or locations, which represent points where they could be reached. Second, there is a mechanism in SIP that allows one to subscribe to a user's presence. The result of a successful subscription would be a notification of a person's availability (or multiple notifications) and, further, from which contacts an individual is available (e.g. reachable at a home number, an office number, a mobile number, etc.). Third, the same subscription mechanism readily accommodates a dialog package using which the status of an ongoing dialog may be reported. Fourth, the SIP platform provides a mechanism for specifying coverage preferences, which can be dynamically set by the end user: either at an end device (e.g. an IP phone), at a web interface, or at an administration level, as is the case in traditional group pick-ups. All of this information could be part of the presence information or dialog information, which is provided by the reach me cover me feature.

Referring now to the flowchart, it may begin at step 100, where endpoint 12a seeks to communicate with endpoint 12b. Endpoint 12a, which is enabled with the new reach me cover me function as outlined herein, can autonomously execute any number of operations. For example, at step 102 the end user associated with endpoint 12a may seek to utilize a list that includes any number of potential target called parties. A person can be added to the cover me or reach me list (e.g. dynamically though use of SIP subscriptions) such that the subscribing party is informed of a person's dialog and/or presence information. This subscription can be dynamically allowed by the called or the covered party or any suitable combination of these elements. Hence, any given entity may dynamically build a list of people to be monitored, whereby these selections are not necessarily preconfigured by an administrator.

At step 104, the feature initiator can chose to monitor one or more contacts for the person being covered or called or the entire persona of that user. The list to be monitored can be a set of pre-defined numbers or the list can be dynamically determined by subscribing to the targeted party's presence (i.e. availability at different contacts such as home phone, mobile phone, IM client). Once the monitored list is defined, the feature will monitor the targeted party's presence and dialog status, as indicated in step 106. This can result in knowing whether a party would like to be reached and/or whether such a party can be reached. Also, additional dialog information provided could include the current dialog status of their line (e.g. idle, alerting or ringing, busy or in use, etc.).

For each target in the monitored list, a unique external or perceivable indication is used to indicate to the caller any number of parameters (associated with dialog and presence information), such as whether: 1) the target's line is idle; 2) the target has indicated they are available to be reached or called; 3) the target's line is ringing and whether it can be answered or picked up; 4) the target's line is in use or busy and/or whether it can be barged into; 5) the target line has a call on hold that can be retrieved; and 6) the target can be reached via certain media types (voice, video, IM, etc.). This is illustrated at step 108. Armed with this dialog and presence information, endpoint 12a may execute any number of operations (e.g. barge, call, set up an alternate media session, etc.) based on individual preferences at step 110.

Yet another example operation is illustrated by the embodiment of FIG. 3. FIG. 3 is a simplified block diagram of an example process on the communication system of 10. FIG. 3 includes Steve and Denise, who are co-workers capable of communicating with each other using IP telephones 84 and 86. FIG. 3 illustrates a situation in which several employees may be monitored or subscribed to concurrently. Consider the case of a system administrator (Steve), who is responsible for a group of individuals. These individuals may be supported, supervised, or otherwise monitored by the system administrator. Each of these subordinates has a unique persona, which includes an associated phone number.

The system administrator may have a list of such phone numbers for the supported team members. These numbers may be constantly displayed (e.g. using a display 90) to the system administrator (e.g. via a reach me cover me list). The reach me cover me feature of the present invention operates to subscribe to the necessary data sources to be notified of the dialog and presence statuses of all of the individuals of the list. The identified status/information for each individual may include their device status (e.g. off hook, on hook, busy, etc.), as well as their reachability modes (e.g. Bill is reachable through IM; Denise is reachable through a wireless telephone, etc).

If the system administrator is monitoring a given employee (e.g. Denise in this example), Steve's line has effectively subscribed to this extension's status. When Denise's phone rings, the system administrator can view an icon (e.g. a ringing telephone) on his device that indicates that Denise's phone is ringing. In another instance, if the system administrator is monitoring Denise and he sees on his display (e.g. on his computer or on his IP telephone) an idle or on-hook icon, the same reach me cover me button could be pressed in order to simply call Denise. In still another scenario, Steve's assistant (not shown) could effectively cover Steve's calls. For example, the assistant could see that Steve is busy talking on another line with a customer. The assistant could take an incoming call, which was intended for Steve, and speak to the calling party. Steve, equipped with his reach me cover me-enabled IP telephone, could infer (e.g. via his display) that his assistant has accepted the call. Steve recognizes that his other line is busy. Steve now has the option of barging into the call and speaking with all three parties simultaneously. At this point, the assistant can simply drop off the call.

Thus, communication system 10 allows for the dynamic set of a list of targets (lines) to be monitored. The feature initiator can decide the best action to reach or to cover the monitored person based on the combination of their presence and dialog state. This provides a simple interface to initiate the cover or reach (i.e. one-button push) and indicates the best way to reach or cover a call. The architecture can interpret an intention based on a depressed button selection. In the case of a ringing phone icon being depicted on the display, if the end user presses the reach me cover me button, then the system understands that the end user would like to pick up the phone. In another instance, where the same phone is not ringing, pressing the button would indicate that the end user would like to call a given individual. The system recognizes that, because the end user understands the state of the targeted individual, it can rely on the end user button selection to execute a given function. Finally, communication system 10 allows the monitored lists to be set up dynamically by any common user interface (versus other systems that require one to be part of shared lines and/or pick up groups or that require an entry of feature codes before picking up a call ringing on a line being monitored).

Note that the benefits of the reach me cover me feature can be achieved by a single person or endpoint in cases where the contacted or monitored endpoint is using a standard analog telephone. The person invoking this feature can still ascertain the identity of the calling party. Hence, even in cases where Denise uses a traditional telephone set-up, Steve would still be able to identify her relevant characteristics.

It is important to note that the stages and steps in FIGS. 2 through 3 illustrate only some of the possible scenarios that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within communication system 10 to effectuate the tasks and operations of the elements and activities associated with executing reach me cover me functions.

Although the present invention has been described in detail with reference to particular embodiments, it should be understood that various other changes, substitutions, and alterations may be made hereto without departing from the spirit and scope of the present invention. For example, the illustrated network architecture of FIG. 1 has only been offered for purposes of example and teaching. Suitable alternatives and substitutions are envisioned and contemplated by the present invention: such alternatives and substitutions being clearly within the broad scope of communication system 10. For example, the use of the LAN could easily be replaced by a virtual private network (VPN), a metropolitan area network (MAN), a wide area network (WAN), a wireless LAN (WLAN), or any other element that facilitates data propagation for endpoints 12a-d. Using analogous reasoning, the routers and switches illustrated by FIG. 1 may be supplanted by bridges, gateways, or any other suitable devices that are conducive to network communications.

Numerous other changes, substitutions, variations, alterations, and modifications may be ascertained by one skilled in the art and it is intended that the present invention encompass all such changes, substitutions, variations, alterations, and modifications as falling within the spirit and scope of the appended claims.

What is claimed is:

1. A method for facilitating communications in a Session Initiation Protocol (SIP) environment, comprising:
receiving, by a first endpoint, dialog and presence information, wherein the first and second endpoints are operable to conduct a SIP communication system, and wherein the dialog and presence information is associated with the second endpoint.

2. The method of claim 1, further comprising:
performing a selected one of a plurality of operations after reviewing the dialog and presence information, wherein the selected operation is one of a call setup operation, a call pickup operation, and a call barge operation.

3. The method of claim 1, further comprising:
displaying the dialog and presence information for the second endpoint.

4. The method of claim 1, wherein the second endpoint is part of a called persons list or a covered persons list that is part of a pre-defined group.

5. The method of claim 1, wherein the second endpoint is part of a called persons list or a covered persons list, which were generated dynamically.

6. The method of claim 1, further comprising:
participating in the SIP communication session that involves the second endpoint after reviewing the dialog and presence information.

7. The method of claim 1, further comprising:
inviting one or more additional endpoints to participate in the SIP communication session, wherein additional dialog and presence information associated with the additional endpoints may be provided to the first endpoint.

8. An apparatus for communicating data in a Session Initiation Protocol (SIP) environment, comprising:
a first endpoint operable to receive dialog and presence information associated with a second endpoint, wherein the first and second endpoints are operable to conduct a SIP communication system.

9. The apparatus of claim 8, wherein the first endpoint is further operable to perform a selected one of a plurality of operations after reviewing the dialog and presence information, and wherein the selected operation is one of a call setup operation, a call pickup operation, and a call barge operation.

10. The apparatus of claim 8, wherein the first endpoint is further operable to display the dialog and presence information of the second endpoint.

11. The apparatus of claim 8, wherein the second endpoint is part of a called persons list or a covered persons list that is part of a pre-defined group.

12. The apparatus of claim 8, wherein the second endpoint is part of a called persons list or a covered persons list, which were generated dynamically.

13. The apparatus of claim 8, wherein the first endpoint is further operable to participate in the SIP communication session that involves the second endpoint after reviewing the dialog and presence information.

14. The apparatus of claim 8, wherein the first endpoint is further operable to invite one or more additional endpoints to participate in the SIP communication session, wherein additional dialog and presence information associated with the additional endpoints may be provided to the first endpoint.

15. Software for facilitating communication in a Session Initiation Protocol (SIP) environment, the software being embodied in a computer readable medium and comprising computer code such that when executed is operable to:
receive, at a first endpoint, dialog and presence information, wherein the first and second endpoints are operable to conduct a SIP communication system, and wherein the dialog and presence information is associated with the second endpoint.

16. The medium of claim 15, wherein the code is further operable to:
perform a selected one of a plurality of operations after reviewing the dialog and presence information, wherein the selected operation is one of a call setup operation, a call pickup operation, and a call barge operation.

17. The medium of claim 15, wherein the code is further operable to:
display the dialog and presence information for the second endpoint.

18. The medium of claim 15, wherein the second endpoint is part of a called persons list or a covered persons list that is part of a pre-defined group.

19. The medium of claim 15, wherein the second endpoint is part of a called persons list or a covered persons list, which were generated dynamically.

20. The medium of claim 15, wherein the code is further operable to:
participate in the SIP communication session that involves the second endpoint after reviewing the dialog and presence information.

21. The medium of claim 15, wherein the code is further operable to:
invite one or more additional endpoints to participate in the SIP communication session, wherein additional dialog and presence information associated with the additional endpoints may be provided to the first endpoint.
